(19) United States
(12) Patent Application Publication
(10) Pub. No.: US 2026/0154968 A1
(43) Pub. Date: Jun. 4, 2026

(54) TRACK RECOGNITION METHOD BASED ON RESIDUAL NETWORK

(71) Applicants: Shanghai Zegao Electronic Engineering Technology Co., Ltd., Shanghai (CN); Suzhou Tongruixing Technology Co., Ltd., Taicang (CN)

(72) Inventors: Lanxin Xie, Taicang (CN); Tuo Shen, Taicang (CN); Shoujun Zhao, Taicang (CN)

(21) Appl. No.: 19/318,412

(22) Filed: Sep. 4, 2025

(30) Foreign Application Priority Data
Dec. 3, 2024 (CN) 202411757304.2

(51) Int. Cl. G06V 20/56; G06V 10/774; G06V 10/776; G06V 10/82

(52) U.S. Cl. CPC G06V 20/56; G06V 10/774; G06V 10/776; G06V 10/82

(57) ABSTRACT

A track recognition method based on a residual network is provided, including the following steps: step 1, obtaining, based on a track dataset, a track recognition model through network training by using a residual network method; and step 2, acquiring a real-time track image, and inputting the real-time track image into the track recognition model to obtain track coordinates. The image feature extraction effect of this method is significantly improved compared with commonly used segmentation network models, and a network structure parameter level of this method is suitable for real-time computation and edge deployment. A loss function of this method incorporates existing linear characteristics of track lines, thereby significantly improving training effect. Moreover, this method avoids a problem of multiple results being difficult to choose from in general segmentation models, adaptively distinguishing track switch directions, with a target track number being only one.

### CROSS-REFERENCE TO RELATED APPLICATION

This application claims priority to Chinese Patent Application No. 202411757304.2, filed on Dec. 3, 2024, which is herein incorporated by reference in its entirety.

### TECHNICAL FIELD

The disclosure relates to the field of rail transit safety, and more particularly to a track recognition method based on a residual network.

### BACKGROUND

Active obstacle detection system is one of important systems for the safe operation of rail transit, and decision-making of obstacle detection results relies on a track region identified by track recognition. Currently, many scholars use traditional machine vision methods or segmentation models to achieve track recognition. However, the traditional machine vision methods involve complex parameter adjustments and lack robustness across different environments, and the segmentation models fail to account for the unique characteristics of track geometry. General segmentation models are unable to autonomously distinguish a current track where a train is located, often mistakenly identifying other non-target tracks as part of the current track of the train.

### SUMMARY

The disclosure provides a track recognition method based on a residual network to solve problems in the related art. A technical solution adopted by the disclosure is as follows.

A track recognition method based on a residual network, includes the following steps:
step 1, obtaining, based on a track dataset, a track recognition model through network training by using a residual network method; and
step 2, acquiring, by a camera mounted on a rail vehicle, a real-time track image, and inputting the real-time track image into the track recognition model to obtain track coordinates.

In an exemplary embodiment, the track recognition method based on the residual network further includes:
step 3, sending the track coordinates to a control system of the rail vehicle, determining, according to the track coordinates and by the control system, a drivable area for the rail vehicle, and detecting obstacles in the drivable area to thereby ensure safe operation of the rail vehicle.

In an embodiment, the step 1 includes:
step 11, constructing the residual network (i.e., residual neural network); and
step 12, importing the track dataset into the residual network for training to obtain a trained residual network as the track recognition model.

In an embodiment, the residual network is based on a residual network 18 (ResNet18) structure and includes 17 convolutional layers, 2 pooling layers, 1 Flatten layer, and 2 fully connected layers.

The convolutional layers are configured to extract image features. One of the pooling layers is configured to perform average pooling, and the other of the pooling layers is configured to perform max pooling. The Flatten layer is configured to convert output data from a previous layer into a one-dimensional array. The fully connected layers are configured to map feature representations of the convolutional layers and the pooling layers to labels of images in the track dataset. A structure of the residual network is as follows:
a first layer is a convolutional layer with 64 convolutional kernels of size 7×7, and with a stride of 2;
a second layer is a max pooling layer with a window size of 3×3 and a stride of 2;
a third layer through a sixth layer are convolutional layers with 64 convolutional kernels of size 3×3, and with a stride of 1;
a seventh layer through a tenth layer are convolutional layers with 128 convolutional kernels of size 3×3, a stride of the seventh layer is 2, and a stride of each of an eighth layer through the tenth layer is 1;
an eleventh layer through a fourteenth layer are convolutional layers with 256 convolutional kernels of size 3×3, a stride of the eleventh layer is 2, and a stride of each of a twelfth layer through the fourteenth layer is 1;
a fifteenth layer through an eighteenth layer are convolutional layers with 512 convolutional kernels of size 3×3, a stride of the fifteenth layer is 2, and a stride of each of a sixteenth layer through the eighteenth layer is 1;
a nineteenth layer is an average pooling layer;
a twentieth layer is the Flatten layer, and is configured to transform data with a size of 8×16×16 into a first vector with a length of 2048;
a twenty-first layer is a first fully connected layer, and is configured to output a second vector with a length of 2048; and
a twenty-second layer is a second fully connected layer, and is configured to output a third vector with a length of 129;
The residual network further includes an activation function to perform one-sided suppression, and the activation function is a rectified linear unit (RELU) activation function with a formula expressed as follows:

$$f ( x ) = max ( 0 , x )$$

where x represents an input vector.

In an embodiment, the step 12 includes:
step 12a, inputting a training image in the track dataset into the residual network, to process the training image through the convolutional layers or the pooling layers, and calculate a training feature map by the activation function, and inputting the training feature map into the fully connected layers to obtain a final training detection result;
step 12b, analyzing the final training detection result, wherein x_{i.l} represents a predicted abscissa of a left rail, x_{i.r} represents a predicted abscissa of a right rail, T represents a number of ordinates after truncation, yₘ represents a T-th ordinate, and a range of i is [1, T]; and
step 12c, calculating a value of a loss function L, where the value of the loss function L includes a geometric loss Lₜ and a cutoff loss Lₘ with a formula expressed as follows:

$$L = {L}_{t} + λ {L}_{m}$$

where λ represents a ratio;
   where the geometric loss Lₜ is calculated as per the following formula:

$${L}_{t} = {\sum }_{i = 1}^{T} \frac{g ( {\hat{x}}_{i , l} - {x}_{i , l} , {β}_{t} ) + g ( {\hat{x}}_{i , r} - {x}_{i , r} , {β}_{t} )}{T ( {x}_{i , r} - {x}_{i , l} )}$$

where a superscript \hat{ } represents a true value, βₜ represents a proportionality smoothing point for the geometric loss, and a smoothing function g(×, β) for a proportionality smoothing point β is as follows:

$$g ( x , β ) = \{ \begin{matrix}0.5 {x}^{2} / β , & \vert x \vert < β \\ \vert x \vert - 0.5 β , & \vert x \vert \geq β\end{matrix}$$

where the cutoff loss Lₘ is calculated as per the following formula:

$${L}_{m} = g ( {\hat{y}}_{m} - {y}_{m} , {β}_{m} )$$

where the superscript \hat{ } represents the true value, and βₘ represents a proportionality smoothing point for the cutoff loss; and
step 12d, iteratively updating network parameters of the residual network by using a stochastic optimization method with adaptive momentum, and recalculating the value of the loss function until the value of the loss function converges or a predetermined number of iterations is reached.

In an embodiment, the step 2 includes: inputting the real-time track image into the track recognition model, to process the real-time track image through the convolutional layers or the pooling layers, and calculate a real-time feature map by the activation function, and inputting the real-time feature map into the fully connected layers to obtain a final real-time detection result.

The final real-time detection result is a vector with a length of 129. A 1^{st} value through a 64^{th} value represent predicted abscissas of the left rail, denoted as x_{i.l}. A 65^{th} value through a 128^{th} value represent predicted abscissas of the right rail, denoted as x_{i.r}. A 129^{th} represents the number of the ordinates after truncation, denoted as T. The range of i is [1,64].

A number of points for each of the left rail and the right rail is 64, and a corresponding ordinate sequence is an interpolation from a height H of the real-time track image to a value 0, denoted as

$${y}_{i} = \frac{H}{63} ( 64 - i ) ,$$

where the range of i is [1,64]. Based on the number of the ordinates T after truncation, a coordinate sequence for the left rail is

$$( {x}_{i , l} , \frac{H}{63} ( 64 - i ) ) ,$$

and a coordinate sequence for the right rail is

$$( {x}_{i , r} , \frac{H}{63} ( 64 - i ) ) ,$$

where the range of i is [1, T].

The disclosure may achieve the following beneficial effects.

Compared with commonly used segmentation network models, the image feature extraction effect of the track recognition method based on the residual network of the disclosure is significantly improved, and a network structure parameter level of the disclosure is suitable for real-time computation and edge deployment. The loss function of the disclosure incorporates existing linear characteristics of track lines, thereby significantly improving training effect. Moreover, the disclosure avoids a problem of multiple results being difficult to choose from in general segmentation models, adaptively distinguishing trach switch directions, with a target track number being only one.

### BRIEF DESCRIPTION OF DRAWINGS

FIG. 1 illustrates a flowchart of a track recognition method based on a residual network of the disclosure.

FIG. 2 illustrates a schematic diagram of a data flow in the residual network of the disclosure.

FIG. 3 illustrates a schematic diagram of a prediction result according to an embodiment of the disclosure.

### DETAILED DESCRIPTION OF EMBODIMENTS

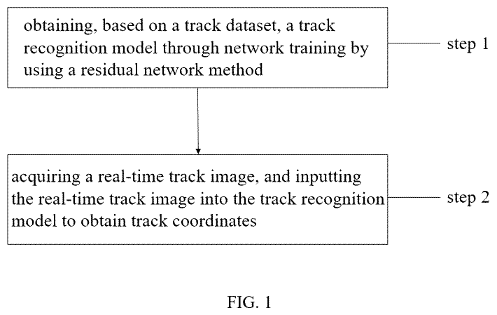

The following is a clear and complete description of the technical solutions of embodiments of the disclosure in conjunction with FIGS. 1-3 of the embodiments of the disclosure. It should be apparent that described embodiments are only a part of the embodiments of the disclosure, not all of them. Unless otherwise specifically indicated, technical means used in the embodiments are conventional means well-known to those skilled in the art.

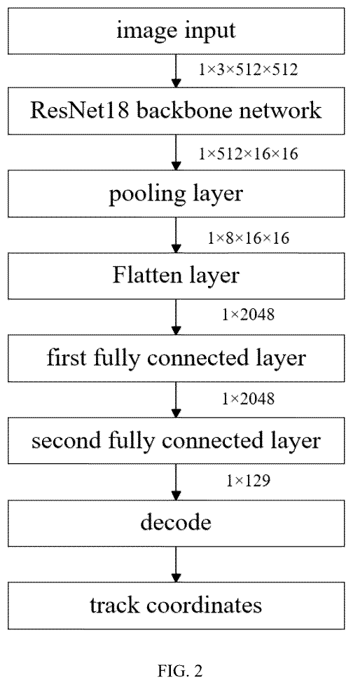

As shown in FIG. 1 and FIG. 2, a track recognition method based on a residual network includes the following steps 1 and 2.

In the step 1, based on a track dataset, a track recognition model is obtained through network training by using a residual network method.

The track dataset in the step 1 consists of images and labels, where each of the labels includes left rail coordinates and right rail coordinates. In an embodiment, there are 59,600 images and their corresponding labels, with 80% allocated to a training set and 20% to a test set.

In the step 2, a real-time track image is acquired, and the real-time track image is input into the track recognition model to obtain track coordinates.

Specifically, the step 1 includes the following steps 11 and 12.

In the step 11, the residual network is constructed.

In the step 12, the track dataset is imported into the residual network established in the step 11 for training, thereby obtaining a residual network with high training accuracy (i.e., a trained residual network), which serves as the track recognition model.

Specifically, the residual network is based on a ResNet18 structure and includes 17 convolutional layers, 2 pooling layers, 1 Flatten layer, and 2 fully connected layers.

The convolutional layers are configured to extract image features. One of the pooling layers is configured to perform average pooling, and the other of the pooling layers is configured to perform max pooling. The Flatten layer is configured convert output data from a previous layer into a one-dimensional array. The fully connected layers are configured to map feature representations of the convolutional layers and the pooling layers to the labels of the images in the track dataset. A structure of the residual network is as follows:
a first layer is a convolutional layer with 64 convolutional kernels of size 7×7, and with a stride of is 2;
a second layer is a max pooling layer with a window size of 3×3 and a stride of 2;
a third layer through a sixth layer are convolutional layers with 64 convolutional kernels of size 3×3, and with a stride of 1;
a seventh layer through a tenth layer are convolutional layers with 128 convolutional kernels of size 3×3, a stride of the seventh layer is 2, and a stride of each of an eighth layer through the tenth layer is 1;
an eleventh layer through a fourteenth layer are convolutional layers with 256 convolutional kernels of size 3×3, a stride of the eleventh layer is 2, and a stride of each of a twelfth layer through the fourteenth layer is 1;
a fifteenth layer through an eighteenth layer are convolutional layers with 512 convolutional kernels of size 3×3, a stride of the fifteenth layer is 2, and a stride of each of a sixteenth layer through the eighteenth layer is 1;
a nineteenth layer is an average pooling layer;
a twentieth layer is the Flatten layer, and is configured to transform data with a size of 8×16× 16 into a first vector with a length of 2048;
a twenty-first layer is a first fully connected layer, and is configured to output a second vector with a length of 2048; and
a twenty-second layer is a second fully connected layer, and is configured to output a third vector with a length of 129.

The residual network further includes an activation function to perform one-sided suppression, and the activation function is a RELU activation function with a formula expressed as follows:

$$f ( x ) = max ( 0 , x )$$

where x represents an input vector.

Specifically, a method for network training in the step 12 includes the following steps 12a through 12d.

In the step 12a, a training image in the track dataset is input into the residual network. The training image is processed through the convolutional layers or the pooling layers, and a training feature map is calculated by the activation function. Then, the training feature map is input into the fully connected layers to obtain a final training detection result.

In the step 12b, the final training detection result is analyzed. In the final training detection result, x_{i.l} represents a predicted abscissa of a left rail, x_{i.r} represents a predicted abscissa of a right rail, T represents a number of ordinates after truncation, yₘ represents a T-th ordinate, and a range of i is [1, T].

In the step 12c, a value of a loss function L is calculated. The value of the loss function L includes a geometric loss Lₜ and a cutoff loss Lₘ with a formula expressed as follows:

$$L = {L}_{t} + λ {L}_{m}$$

where λ represents a ratio.

The geometric loss Lₜ is calculated as per the following formula:

$${L}_{t} = {\sum }_{i = 1}^{T} \frac{ℊ ( {\hat{x}}_{i , l} - {x}_{i , l} , {β}_{t} ) + ℊ ( {\hat{x}}_{i , r} - {x}_{i , r} , {β}_{t} )}{T ( {x}_{i , r} - {x}_{i , l} )}$$

where a superscript \hat{ } represents a true value, βₜ represents a proportionality smoothing point for the geometric loss, and a smoothing function g(x, β) for a proportionality smoothing point β is as follows:

$$ℊ ( x , β ) = \{ \begin{matrix}0.5 {x}^{2} / β , \vert x \vert < β \\ \vert x \vert - 0.5 β , \vert x \vert \geq β\end{matrix}$$

The cutoff loss Lₘ is calculated as per the following formula:

$${L}_{m} = ℊ ( {\hat{y}}_{m} - {y}_{m} , {β}_{m} )$$

where the superscript \hat{ } represents the true value, and βₘ represents a proportionality smoothing point for the cutoff loss.

In the step 12c, the ratio λ of the loss function is set to 0.5, the proportionality smoothing point βₜ for the geometric loss is set to 0.004, and the proportionality smoothing point βₘ for the cutoff loss is set to 0.016.

In the step 12d, network parameters of the residual network are iteratively updated by using a stochastic optimization method with adaptive momentum. The value of the loss function is recalculated until the value of the loss function converges or a predetermined number of iterations is reached.

In the method for network training in the step 12, an Adam optimizer is used in the step 12d for network training, the predetermined number of the iterations is set to 500 steps, and a learning rate is set to 0.0001.

Specifically, prediction of the track coordinates in the step 2 includes the following specific operations. First, the real-time track image is input into the track recognition model. The real-time track image is processed through the convolutional layers or the pooling layers, and a real-time feature map is calculated by the activation function. Then, the real-time feature map is input into the fully connected layers to obtain a final real-time detection result.

The final real-time detection result is a vector with a length of 129. A 1^{st} value through a 64^{th} value represent predicted abscissas of the left rail, denoted as x_{i.l}. A 65^{th} value through a 128^{th} value represent predicted abscissas of the right rail, denoted as x_{i.r}. A 129^{th} value represents the number of the ordinates after truncation, denoted as T. The range of i is [1,64].

A number of points for each of the left rail and the right rail is 64, and a corresponding ordinate sequence is an interpolation from a height H of the real-time track image to a value 0, denoted as

$${y}_{i} = \frac{H}{63} ( 64 - i ) ,$$

where the range of i is [1,64]. Based on the number of the ordinates T after truncation, a coordinate sequence for the left rail is

$$( {x}_{i , l} , \frac{H}{63} ( 64 - i ) ) ,$$

and a coordinate sequence for the right rail is

$$( {x}_{i , r} , \frac{H}{63} ( 64 - i ) ) ,$$

where the range of i is [1, T].

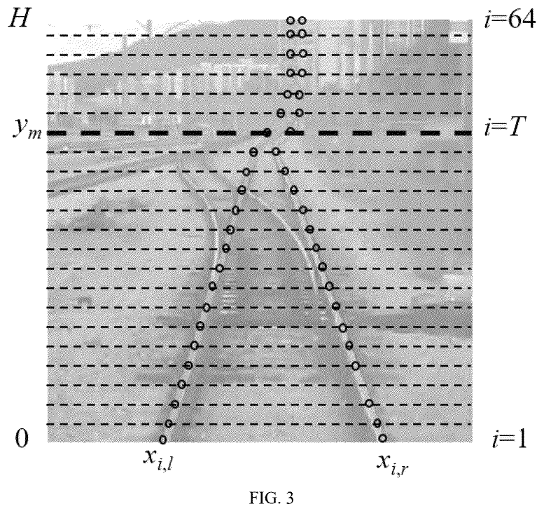

A prediction result of the embodiment of the disclosure is shown in FIG. 3. A size of the real-time track image is 512*512, the track recognition model outputs a total of 128 coordinate points with 64 points for each of the left rail and the right rail, and a truncation value (i.e., the number of the ordinates after truncation) is 50. Final track coordinate results are the coordinate points below a yₘ dashed line in the FIG. 3, with 50 points for each of the left rail and the right rail.

The image feature extraction effect of the disclosure is significantly improved compared with commonly used segmentation network models (step 11), and a network structure parameter level of the disclosure is suitable for real-time computation and edge deployment. The loss function of the disclosure incorporates existing linear characteristics of track lines, thereby significantly improving training effect (step 12). Moreover, the disclosure avoids ta problem of multiple results being difficult to choose from in general segmentation models, adaptively distinguishing track switch directions, with a target track number being only one (step 2).

The embodiments described above are merely specific embodiments of the disclosure and are not intended to limit the scope of the disclosure. Any modifications, variations, substitutions, and other changes made by those skilled in the art to the technical solution of the disclosure, without departing from the spirit of the disclosure, should fall within the scope of protection defined by the appended claims of the disclosure.

What is claimed is:

1. A track recognition method based on a residual network, comprising the following steps:
step 1, obtaining, based on a track dataset, a track recognition model through network training by using a residual network method; and
step 2, acquiring a real-time track image, and inputting the real-time track image into the track recognition model to obtain track coordinates;
wherein the step 2 comprises:
inputting the real-time track image into the track recognition model, to process the real-time track image through convolutional layers or pooling layers, and calculate a real-time feature map by an activation function, and inputting the real-time feature map into fully connected layers to obtain a final real-time detection result;
wherein the final real-time detection result is a vector with a length of 129, a 1^{st} value through a 64^{th} value represent predicted abscissas of a left rail, denoted as x_{i.l}; a 65^{th} value through a 128^{th} value represent predicted abscissas of a right rail, denoted as x_{i.r}; a 129^{th} value represents a number of ordinates after truncation, denoted as T; and a range of i is [1,64]; and
wherein a number of points for each of the left rail and the right rail is 64, and a corresponding ordinate sequence is an interpolation from a height H of the real-time track image to a value 0, denoted as
$${y}_{i} = \frac{H}{63} ( 64 - i ) ,$$
where the range of i is [1,64]; based on the number of the ordinates T after truncation, a coordinate sequence for the left rail is
$$( {x}_{i , l} , \frac{H}{63} ( 64 - i ) ) ,$$
and a coordinate sequence for the right rail is
$$( {x}_{i , r} , \frac{H}{63} ( 64 - i ) ) ,$$
where the range of i is [1, T];
wherein the step 1 comprises:
step 11, constructing the residual network; and
step 12, importing the track dataset into the residual network for training to obtain a trained residual network as the track recognition model;
wherein the residual network is based on a residual network 18 (ResNet18) structure and comprises 17 convolutional layers, 2 pooling layers, 1 Flatten layer, and 2 fully connected layers;
wherein the convolutional layers are configured to extract image features, one of the pooling layers is configured to perform average pooling, the Flatten layer is configured to convert output data from a previous layer into a one-dimensional array, and the fully connected layers are configured to map feature representations of the convolutional layers and the pooling layers to labels of images in the track dataset; and a structure of the residual network is as follows:
a first layer is a convolutional layer with 64 convolutional kernels of size 7×7, and with a stride of 2;
a second layer is a max pooling layer with a window size of 3×3 and a stride of 2;
a third layer through a sixth layer are convolutional layers with 64 convolutional kernels of size 3×3, and with a stride of 1;
a seventh layer through a tenth layer are convolutional layers with 128 convolutional kernels of size 3×3, a stride of the seventh layer is 2, and a stride of each of an eighth layer through the tenth layer is 1;
an eleventh layer through a fourteenth layer are convolutional layers with 256 convolutional kernels of size 3×3, a stride of the eleventh layer is 2, and a stride of each of a twelfth layer through the fourteenth layer is 1;
a fifteenth layer through an eighteenth layer are convolutional layers with 512 convolutional kernels of size 3×3, a stride of the fifteenth layer is 2, and a stride of each of a sixteenth layer through the eighteenth layer is 1;
a nineteenth layer is an average pooling layer;
a twentieth layer is the Flatten layer, and is configured to transform data with a size of 8×16×16 into a first vector with a length of 2048;
a twenty-first layer is a first fully connected layer, and is configured to output a second vector with a length of 2048; and
a twenty-second layer is a second fully connected layer, and is configured to output a third vector with a length of 129;
wherein the residual network further comprises the activation function to perform one-sided suppression, and the activation function is a rectified linear unit (RELU) activation function with a formula expressed as follows:
$$f ( x ) = max ( 0 , x )$$
wherein x represents an input vector;
wherein the step 12 comprises:
step 12a, inputting a training image in the track dataset into the residual network, to process the training image through the convolutional layers or the pooling layers, and calculate a training feature map by the activation function, and inputting the training feature map into the fully connected layers to obtain a final training detection result;
step 12b, analyzing the final training detection result, wherein x_{i.l} represents a predicted abscissa of the left rail, x_{i.r} represents a predicted abscissa of the right rail, T represents the number of the ordinates after truncation, yₘ represents a T-th ordinate, and the range of i is [1, T]; and
step 12c, calculating a value of a loss function L, wherein the value of the loss function L comprises a geometric loss Lₜ and a cutoff loss Lₘ with a formula expressed as follows:
$$L = {L}_{t} + λ {L}_{m}$$
wherein λ represents a ratio;
wherein the geometric loss Lₜ is calculated as per the following formula:
$${L}_{t} = {\sum }_{i = 1}^{T} \frac{ℊ ( {\hat{x}}_{i , l} - {x}_{i , l} , {β}_{t} ) + ℊ ( {\hat{x}}_{i , r} - {x}_{i , r} , {β}_{t} )}{T ( {x}_{i , r} - {x}_{i , l} )}$$
where a superscript \hat{ } represents a true value, βₜ represents a proportionality smoothing point for the geometric loss, and a smoothing function g(x, B) for a proportionality smoothing point β is as follows:
$$ℊ ( x , β ) = \{ \begin{matrix}0.5 {x}^{2} / β , \vert x \vert < β \\ \vert x \vert - 0.5 β , \vert x \vert \geq β\end{matrix}$$
wherein the cutoff loss Lₘ is calculated as per the following formula:
$${L}_{m} = ℊ ( {\hat{y}}_{m} - {y}_{m} , {β}_{m} )$$
where the superscript \hat{ } represents the true value, and βₘ represents a proportionality smoothing point for the cutoff loss; and
step 12d, iteratively updating network parameters of the residual network by using a stochastic optimization method with adaptive momentum, and recalculating the value of the loss function until the value of the loss function converges or a predetermined number of iterations is reached.
